(19) United States
(12) Patent Application Publication
(10) Pub. No.: US 2026/0121090 A1
(43) Pub. Date: Apr. 30, 2026

(54) VEHICLE FUEL CELL WAKEUP TO CONDITION OPERATIONAL STRATEGY

(71) Applicant: FCA US LLC, Auburn Hills, MI (US)

(72) Inventors: Magdalena Krasny, Auburn Hills, MI (US); Jacob Belin, Auburn Hills, MI (US); Jash Murjani, Auburn Hills, MI (US); Rudolf Kharpuri, Auburn Hills, MI (US); Marc S. Reischmann, Auburn Hills, MI (US); Andrew M. Huisjen, Auburn Hills, MI (US)

(21) Appl. No.: 18/932,682

(22) Filed: Oct. 31, 2024

(51) Int. Cl. H01M 8/0432; H01M 8/04302; H01M 8/04537; H01M 8/04701; H01M 8/04828

(52) U.S. Cl. CPC H01M 8/0432; H01M 8/04302; H01M 8/04656; H01M 8/04701; H01M 8/04828; H01M 2250/20

(57) ABSTRACT

A fuel cell wakeup and conditioning system for a fuel cell electric vehicle (FCEV) initiate a wakeup timer for periodically waking up a fuel cell power system (FCPS) to perform at least one of thermal and humidity conditioning, based on the wakeup timer, a state of charge (SOC) of a high voltage battery system of the FCEV, and an ambient temperature, determine whether to perform (i) only thermal conditioning of the FCPS or (ii) both thermal and humidity conditioning of the FCPS and, based on the determination, control only a thermal conditioning system to perform thermal conditioning of the FCPS or (ii) both the thermal conditioning system and a humidity conditioning system to perform thermal and humidity conditioning of the FCPS.

### FIELD

The present application generally relates to fuel cell electric vehicles (FCEVs) and, more particularly, to a fuel cell wakeup to condition operational strategy for FCEVs.

### BACKGROUND

A fuel cell electric vehicle (FCEV) comprises an electrochemical fuel cell system that generates electricity using a fuel (e.g., hydrogen, or H2). When H2 is combined with oxygen (from air), it produces electrical energy with only heat and water as byproducts. In FCEVs, the fuel cell system operates a secondary power source for periodically providing electrical energy to recharge a high voltage battery pack or system. Due to the presence of water in the fuel cell system, a freeze preparation strategy is often initiated upon shutdown. Conventional fuel cell control systems execute this freeze preparation strategy without regard to ambient temperature, which could cause customer dissatisfaction due to excess shutdown and startup times (and thus a delay in propulsion system power) in addition to fuel cell system durability concerns (premature membrane degradation due to excess time in an overly dry state). Accordingly, while such conventional fuel cell control systems do work for their intended purpose, there exists an opportunity for improvement in the relevant art.

### SUMMARY

According to one example aspect of the invention, a fuel cell wakeup and conditioning system for a fuel cell electric vehicle (FCEV) is presented. In one exemplary implementation, the fuel cell wakeup and conditioning system comprises a thermal conditioning system configured to control a temperature of a fuel cell power system (FCPS) of the FCEV, wherein the FCPS comprises a hydrogen (H2) fuel cell stack that is configured to selectively generate electrical energy for recharging a high voltage battery system of the FCEV, a humidity conditioning system configured to control a humidity of the FCPS, and a control system configured to initiate a wakeup timer for periodically waking up the FCPS to perform at least one of thermal and humidity conditioning, based on the wakeup timer, a state of charge (SOC) of the high voltage battery system of the FCEV, and an ambient temperature, determine whether to perform (i) only thermal conditioning of the FCPS or (ii) both thermal and humidity conditioning of the FCPS, and based on the determination, control only the thermal conditioning system to perform thermal conditioning of the FCPS or (ii) both the thermal and humidity conditioning systems to perform thermal and humidity conditioning of the FCPS.

In some implementations, the control system is configured to determine whether to perform (i) only thermal conditioning of the FCPS or (ii) both thermal and humidity conditioning of the FCPS in response to expiration of the wakeup timer. In some implementations, the control system is further configured to, after the thermal only or thermal and humidity conditioning of the FCPS, recalculate the wakeup timer for a subsequent periodic wakeup and conditioning event. In some implementations, the wakeup timer (tₜᵢₘₑᵣ) is calculated as:

$${T}_{FCmin} = {T}_{a m b} + ( {T}_{0} - {T}_{a m b} ) {e}^{- HWD * {t}_{t i m e r}} , and$$

$${t}_{timer} = \frac{1}{{r}_{fc}} ln ( \frac{{T}_{FCmin} - {T}_{a m b}}{{T}_{0} - {T}_{a m b}} ) ,$$

where r_{fc} represents is a fuel cell constant or rate of change, T_{amb} represents the ambient temperature, T₀ represents a timer measured at shutdown of the FCPS and updated upon each wakeup after conditioning and to estimate subsequent timers, HWD represents a fuel cell hardware decay rate, and T_{FCmin} represents a minimum fuel cell temperature.

In some implementations, the control system is configured to determine to perform only thermal conditioning of the FCPS when the SOC of the high voltage battery system exceeds a maximum SOC threshold. In some implementations, the control system is configured to determine to perform only thermal conditioning of the FCPS when the FCEV is plugged-in for charging of the high voltage battery system. In some implementations, the control system is configured to perform at least thermal conditioning of the FCPS when the ambient temperature is below an ambient temperature threshold corresponding to a freezing condition of the FCPS. In some implementations, the control system is configured to control the humidity conditioning system such that a humidity in the FCPS is below a first humidity threshold corresponding to a freezing condition of the FCPS and above a lower second humidity threshold corresponding to a potentially damaging drying condition of the FCPS. In some implementations, the humidity conditioning system comprises a humidifier.

According to another example aspect of the invention, a fuel cell wakeup and conditioning method for an FCEV is presented. In one exemplary implementation, the fuel cell wakeup and conditioning method comprises providing a thermal conditioning system configured to control a temperature of an FCPS of the FCEV, wherein the FCPS comprises an H2 fuel cell stack that is configured to selectively generate electrical energy for recharging a high voltage battery system of the FCEV, providing a humidity conditioning system configured to control a humidity of the FCPS, initiating, by a control system of the FCEV, a wakeup timer for periodically waking up the FCPS to perform at least one of thermal and humidity conditioning, based on the wakeup timer, an SOC of the high voltage battery system of the FCEV, and an ambient temperature, determining, by the control system, whether to perform (i) only thermal conditioning of the FCPS or (ii) both thermal and humidity conditioning of the FCPS, and based on the determination, controlling, by the control system, only the thermal conditioning system to perform thermal conditioning of the FCPS or (ii) both the thermal and humidity conditioning systems to perform thermal and humidity conditioning of the FCPS.

In some implementations, the determining of whether to perform (i) only thermal conditioning of the FCPS or (ii) both thermal and humidity conditioning of the FCPS is performed in response to expiration of the wakeup timer. In some implementations, the fuel cell wakeup and conditioning method further comprises, after the thermal only or thermal and humidity conditioning of the FCPS, recalculating, by the control system, the wakeup timer for a subsequent periodic wakeup and conditioning event. In some implementations, the wakeup timer (tₜᵢₘₑᵣ) is calculated as:

$${T}_{FCmin} = {T}_{a m b} + ( {T}_{0} - {T}_{a m b} ) {e}^{- HWD * {t}_{t i m e r}} , and$$

$${t}_{timer} = \frac{1}{{r}_{fc}} ln ( \frac{{T}_{FCmin} - {T}_{a m b}}{{T}_{0} - {T}_{a m b}} ) ,$$

where r_{fc} represents is a fuel cell constant or rate of change, T_{amb} represents the ambient temperature, T₀ represents a timer measured at shutdown of the FCPS and updated upon each wakeup after conditioning and to estimate subsequent timers, HWD represents a fuel cell hardware decay rate, and T_{FCmin} represents a minimum fuel cell temperature.

In some implementations, the control system determines to perform only thermal conditioning of the FCPS when the SOC of the high voltage battery system exceeds a maximum SOC threshold. In some implementations, the control system determines to perform only thermal conditioning of the FCPS when the FCEV is plugged-in for charging of the high voltage battery system. In some implementations, the control system performs at least thermal conditioning of the FCPS when the ambient temperature is below an ambient temperature threshold corresponding to a freezing condition of the FCPS. In some implementations, the control system controls the humidity conditioning system such that a humidity in the FCPS is below a first humidity threshold corresponding to a freezing condition of the FCPS and above a lower second humidity threshold corresponding to a potentially damaging drying condition of the FCPS. In some implementations, the humidity conditioning system comprises a humidifier.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a fuel cell electric vehicle (FCEV) having an example fuel cell wakeup and conditioning system according to the principles of the present application;

FIGS. 2A-2C are functional block diagrams of example system architectures and an operational plot for the fuel cell wakeup and conditioning system according to the principles of the present application; and

FIG. 3 is a flow diagram of an example fuel cell wakeup and conditioning method for an FCEV according to the principles of the present application.

### DESCRIPTION

As previously discussed, due to the presence of water in a fuel cell system of a fuel cell electric vehicle (FCEV), a freeze preparation strategy is often initiated upon shutdown. Conventional fuel cell control systems execute this freeze preparation strategy without regard to ambient temperature, which could cause customer dissatisfaction due to excess shutdown and startup times (and thus a delay in propulsion system power) in addition to fuel cell system durability concerns (premature membrane degradation due to excess time in an overly dry state). Accordingly, a periodic wakeup and conditioning operational strategy for a fuel cell system of an FCEV is presented herein. This procedure is executed in specific conditions, such as in high state of charge (SOC) scenarios (e.g., where battery system SOC must first be depleted such that the fuel cell system is able to run and generate electrical energy) and when cold ambient temperatures are detected. The conditioning types are (1) thermal conditioning to above a minimum temperature, to prevent icing upon shutdown, and (2) internal humidity conditioning to below a minimum humidity, to prevent icing upon shutdown and also avoid excessively dry conditions that could degrade the fuel cell membrane. In some embodiments, a timer could be set after each wakeup and conditioning routine and utilized to perform or check for subsequent wakeup/conditioning routines.

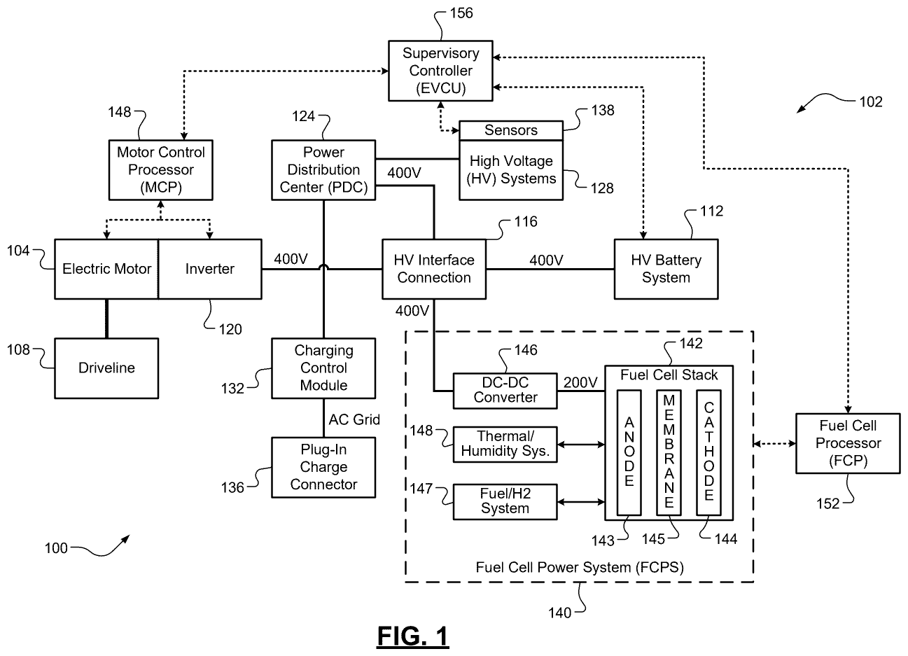

Referring now to FIG. 1, a diagram of a FCEV 100 having an example fuel cell wakeup and conditioning system 102 according to the principles of the present application is illustrated. The FCEV 100 is controlled by a supervisory controller (EVCU) 156 and comprises one or more electric motors 104 (e.g., a three-phase electric traction motor) configured to generate drive torque that is transferred directly or via a transmission (not shown) to a driveline 108 of the FCEV 100 or to generate regenerative power by converting mechanical energy from the driveline 108. The EVCU 156 can be configured to perform the periodic fuel cell system wakeup and conditioning as discussed in greater detail herein. The electric motor 104 connected to a high voltage (HV) DC bus and to a HV battery system 112 (a HV battery pack, a battery pack control module (BPCM), HV contactors, etc.) via a HV interface connection 116 and a three-phase inverter 120, which are controlled by an MCP 148. While the HV DC bus is shown to be 400V DC, it will be appreciated that the FCEV 100 could be powered by a different HV DC power magnitude (e.g., 800V DC).

The HV DC bus is also connected to a power distribution center (PDC) 124, which is connected to other HV systems 128 (an electric air compressor, one or more electric heaters, etc.) and also to a charging control module 132 (e.g., an on-board charging or integrated dual charging module, or OBCM/IDCM). The charging control module 132 is selectively connectable to external alternating current (AC) power, such as an AC grid or charging station, via a plug-in charge connector 136. A fuel cell system, or “fuel cell power system” (FCPS) 140, comprises a fuel cell (FC) stack (also “FCS”) 142 (e.g., a hydrogen, or H2 FCS) configured to perform a chemical reaction to generate and output another different HV DC power and is controlled by a fuel cell processor (FCP) 152. As shown, the fuel cell stack 142 comprises an anode 143 that circulates the fuel (H2) therethrough using a fuel/H2 system 147 and a cathode 143 that circulates oxygen (from air) therethrough and outputs air and water vapor. Thermal/humidity conditioning of the FCPS 140 (the fuel cell stack 142) is controlled by a thermal/humidity system 148 (valves, a fan/radiator, a humidifier, etc.). It will be appreciated that the thermal and humidity control systems could also be separate systems rather than a single system 148 as shown merely for illustrative purposes.

A membrane 145 (e.g., a proton exchange membrane) is arranged between the anode 143 and the cathode 144. While not specifically shown, there each fuel cell of the fuel cell stack 142 could further comprise a gas diffusion layer (not shown) and a catalyst (not shown) on each side where an electrical current (i.e., a flow of electrons) is generated therefrom. While a single cell example of the fuel cell stack 142 is illustrated, it will be appreciated that the fuel cell stack 142 could include a plurality of fuel cells stacked together (e.g., in a sandwich-type configuration using bipolar plates). While this other different HV DC power generated by the fuel cell stack 142 is shown to be 200V, it will be appreciated that the FCPS 140 could be configured to output a lesser or greater HV DC power magnitude. A DC-DC converter 146, which could be part of or separate from the FCPS 140, is configured to step-up or boost the lower HV DC power output by the FCPS 140 (e.g., 200V DC) to the higher HV DC power at the HV interface connection 116 (e.g., 400V DC). The EVCU 156 and the FCP 152 are also configured to execute at least a portion of the periodic fuel cell system wakeup and conditioning techniques of the present application, which will now be described in greater detail below.

The primary objective of the periodic fuel cell wakeup and conditioning feature is to wakeup the relevant ECUs (ECVU 156, FCP 152, a battery pack control module, or BPCM, etc.) to condition the FC stack 142 in order to decrease startup/shutdown time in normal ambient conditions (e.g., temperature and/or humidity) and to improve fuel cell durability. Periodic wakeup allows the FC stack 142 to enter shutdown at a wider range of temperatures, and thus a variable rate timer is required to drive the periodic conditioning. One type of conditioning is FC stack thermal conditioning, as the FC stack and the fuel/H2 storage need to remain above a minimum temperature when shutdown to prevent component icing and degradation. The other type of conditioning is internal FC membrane conditioning (also referred to herein as humidity conditioning), as the FC stack humidity must be controlled to prevent icing and fuel cell degradation and the membrane humidity must be controlled via a humidifier drying procedure (e.g., using a humidifier of thermal/humidity system 148) and purging of the anode/cathode loops. In this process, fuel cell impedance can be measured to assess the drying status. Active drying involves an anode pressure change, whereas neutral drying involves maintaining a humidity target. A FC handshake defines the logic and interface for deciding what combination of thermal conditioning and internal humidity conditioning will be executed during each periodic wakeup.

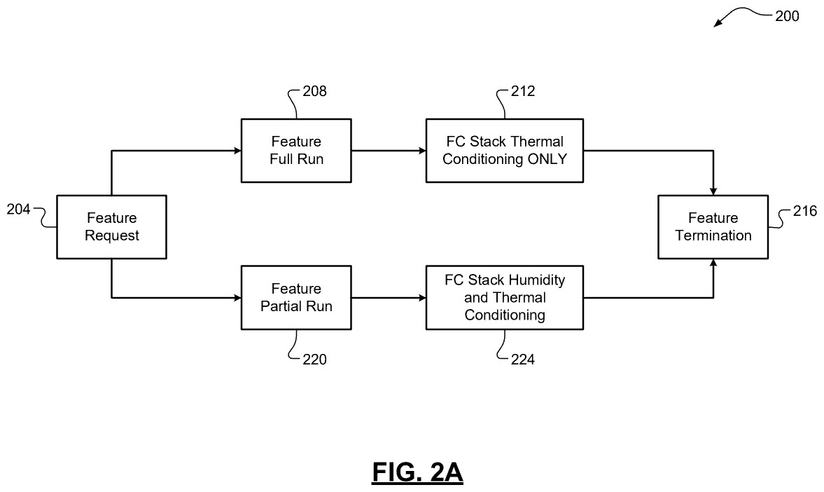

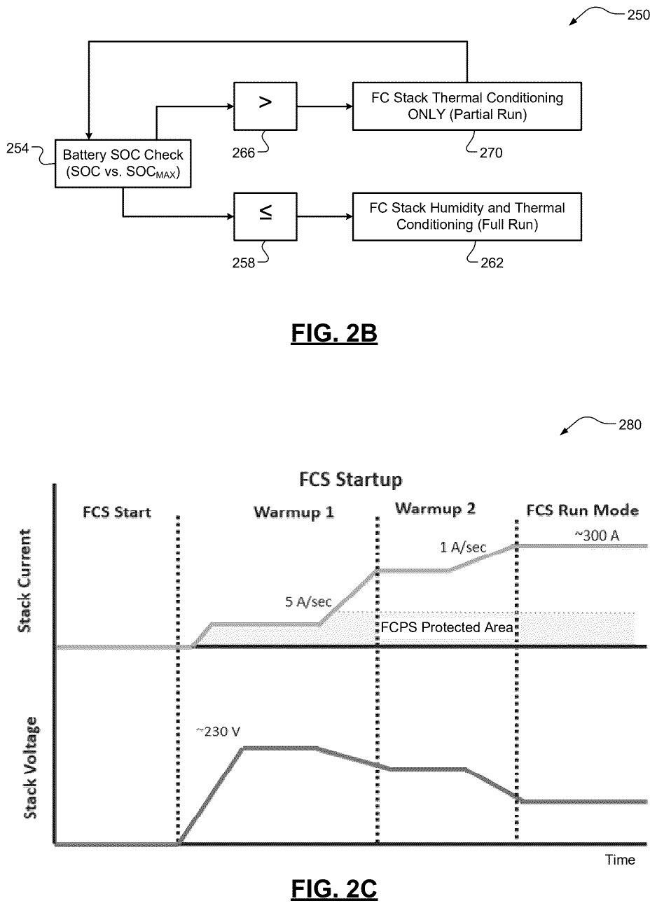

Referring now to FIGS. 2A-2C and with continued reference to FIG. 1, functional block diagrams of example system architectures 200, 250 and an operational plot 280 for the fuel cell wakeup and conditioning system 102 according to the principles of the present application are illustrated. As shown in architecture 200 of FIG. 2A, the wakeup to condition feature has two different operational modes: (1) a feature full run and (2) a feature partial run. After an initial feature request 204, a feature full run is determined at 208 and then both thermal and humidity conditioning is performed at 212, before the feature ends or terminates at 216. However, a feature partial run could be determined at 220 (instead of the full feature run determination at 208), such as when running the FC stack 142 (the FCPS 140) is inhibited. This could occur, for example, when the SOC of the battery system 112 is too high (and thus there is nowhere for the energy generated by the FCPS 140 to go) or when the FCEV 100 is plugged-in for plug-in charging (via plug-in charge connector 136, as controlled by charging control module 132). In other words, when the FCEV 100 is plugged in, SOC consumption is not a concern and thus nominal FC shutdown (without regard to ambient temperature) is to be performed.

In such a partial feature run, the FC thermal targets increase and the wakeup timer also decreases based on the thermal targets. For example only, the wakeup timer (tₜᵢₘₑᵣ) could be calculated as follows:

$${T}_{FCmin} = {T}_{a m b} + ( {T}_{0} - {T}_{a m b} ) {e}^{- HWD * {t}_{t i m e r}} , and$$

$${t}_{timer} = \frac{1}{{r}_{fc}} ln ( \frac{{T}_{FCmin} - {T}_{a m b}}{{T}_{0} - {T}_{a m b}} ) ,$$

where r_{fc} represents is a fuel cell constant or rate of change, T_{amb} represents ambient temperature, To represents a timer measured at shutdown and updated upon each wakeup after conditioning and to estimate subsequent timers, HWD represents a fuel cell hardware decay rate, and T_{FCmin} represents a minimum fuel cell temperature, which increases to further protect against freezing conditions on the FC stack 142 (i.e., the wakeup timer tₜᵢₘₑᵣ decreases during this specific condition, which corresponds to more frequent monitoring of the FC stack 142). In other words, thermal conditioning is increased during vehicle plug-in (not SOC-limited) to enable an extended shutdown and storage period in nominal conditions for FC stack components. There may also be a special case, however, in the event where charging is complete and the vehicle is then unplugged, and the SOC exceeds the FC stack operational threshold.

In this special case or scenario, SOC must be dissipated before a freeze shutdown and membrane humidification can be completed. For example, the FCPS minimum output power could be 16 kilowatts (kW). Increased thermal conditioning is then necessary to support the FC stack 142 for vehicle plug-in considerations. If the SOC returns to an acceptable window for FC stack operation, normal conditioning feature operation is enabled. This is illustrated in system architecture 250 of FIG. 2B and the plot 280 of FIG. 2C. At 254, a battery SOC check is performed where the SOC of the battery system 112 is compared to a maximum SOC (SOCMAX). When the SOC is less than or equal to SOCMAX at 258, then the FC stack humidity and conditioning (a full feature run) is performed at 262 and the process ends. Conversely, when the SOC is greater than SOCMAX at 266, then only the FC stack thermal conditioning (a partial feature run) is performed at 270 and then the process returns to 254, where a full feature run could subsequently occur. The plot 280 of FIG. 2C further illustrates the thermal conditioning process for this special case or scenario.

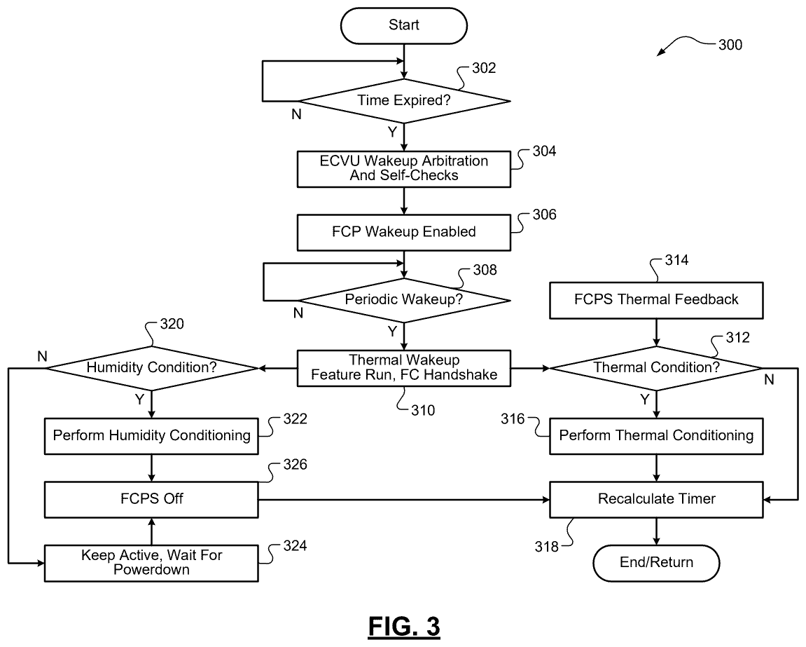

Referring now to FIG. 3 and with continued reference to the previous figures, a flow diagram of an example fuel cell wakeup and conditioning method 300 for a FCEV according to the principles of the present application is illustrated. While the method 300 specifically references the FCEV 100 and its components (e.g., the FCPS 140), it will be appreciated that this method 300 could be applicable to other suitably configured FCEVs. The method 300 begins at 302 where the EVCU 156 determines whether the wakeup timer tₜᵢₘₑᵣ has expired. When false, the method 300 ends or returns to 302. When true, the method 300 proceeds to 304. At 304, the ECVU 156 performs wakeup arbitration (for other ECUs, such as the FCP 152 and a BPCM) and also performs various self-checks (e.g., to detect potential faults or malfunctions). At 306, wakeup of the FCP 152 is enabled. At 308, the EVCU 156 determines whether a periodic wakeup is required. For purposes of this application, this includes periodic wakeup for conditioning (thermal and, in some cases, humidity), but it will be appreciated that other wakeup procedures, such as a wakeup of the BPCM and the battery system 112 for charging (via charging control module 132). When a thermal/humidity conditioning wakeup is necessary, the method 300 proceeds to 310.

At 310, the EVCU 156 begins the wakeup procedure by performing the FC handshake to determine whether to perform a full feature run (thermal and humidity conditioning) or only a partial feature run (only thermal conditioning) as previously discussed herein. Based on this determination, the method 300 could proceed to 312 for thermal conditioning and, in some cases, also to parallel 320 for humidity conditioning. At 312, the EVCU 156 determines whether additional thermal conditioning is necessary. This determination is based on thermal feedback (e.g., measured temperatures) of the FCPS 140. When true, thermal conditioning is performed at 316 (e.g., by controlling the thermal component(s) of the thermal/humidity system 148) and the method 300 proceeds to 318. When 312 is false, the method 300 proceeds directly to 318. At 318, the wakeup timer tₜᵢₘₑᵣ is recalculated and then the method 300 ends or returns to 302. At parallel 320, the EVCU 156 determines whether additional humidity conditioning is necessary. When true, humidity conditioning is performed at 322 (e.g., by controlling the humidifier of the thermal/humidity system 148) and the method 300 proceeds to 324. When 322 is false, the method 300 proceeds directly to 326. At 324, the FCPS 140 is kept active and awaits a powerdown. In response to a powerdown of the FCPS 140, the FCPS 140 turns off at 326 and then the method 300 proceeds to 318 where the timer tₜᵢₘₑᵣ is recalculated.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A fuel cell wakeup and conditioning system for a fuel cell electric vehicle (FCEV), the fuel cell wakeup and conditioning system comprising:
a thermal conditioning system configured to control a temperature of a fuel cell power system (FCPS) of the FCEV, wherein the FCPS comprises a hydrogen (H2) fuel cell stack that is configured to selectively generate electrical energy for recharging a high voltage battery system of the FCEV;
a humidity conditioning system configured to control a humidity of the FCPS; and
a control system configured to:
initiate a wakeup timer for periodically waking up the FCPS to perform at least one of thermal and humidity conditioning;
based on the wakeup timer, a state of charge (SOC) of the high voltage battery system of the FCEV, and an ambient temperature, determine whether to perform (i) only thermal conditioning of the FCPS or (ii) both thermal and humidity conditioning of the FCPS; and
based on the determination, control only the thermal conditioning system to perform thermal conditioning of the FCPS or (ii) both the thermal and humidity conditioning systems to perform thermal and humidity conditioning of the FCPS.

2. The fuel cell wakeup and conditioning system of claim 1, wherein the control system is configured to determine whether to perform (i) only thermal conditioning of the FCPS or (ii) both thermal and humidity conditioning of the FCPS in response to expiration of the wakeup timer.

3. The fuel cell wakeup and conditioning system of claim 2, wherein the control system is further configured to, after the thermal only or thermal and humidity conditioning of the FCPS, recalculate the wakeup timer for a subsequent periodic wakeup and conditioning event.

4. The fuel cell wakeup and conditioning system of claim 3, wherein the wakeup timer (tₜᵢₘₑᵣ) is calculated as:
$${T}_{FCmin} = {T}_{a m b} + ( {T}_{0} - {T}_{a m b} ) {e}^{- HWD * {t}_{t i m e r}} , and$$
$${t}_{timer} = \frac{1}{{r}_{fc}} ln ( \frac{{T}_{FCmin} - {T}_{a m b}}{{T}_{0} - {T}_{a m b}} ) ,$$
where r_{fc} represents is a fuel cell constant or rate of change, T_{amb} represents the ambient temperature, To represents a timer measured at shutdown of the FCPS and updated upon each wakeup after conditioning and to estimate subsequent timers, HWD represents a fuel cell hardware decay rate, and T_{FCmin} represents a minimum fuel cell temperature.

5. The fuel cell wakeup and conditioning system of claim 1, wherein the control system is configured to determine to perform only thermal conditioning of the FCPS when the SOC of the high voltage battery system exceeds a maximum SOC threshold.

6. The fuel cell wakeup and conditioning system of claim 1, wherein the control system is configured to determine to perform only thermal conditioning of the FCPS when the FCEV is plugged-in for charging of the high voltage battery system.

7. The fuel cell wakeup and conditioning system of claim 1, wherein the control system is configured to perform at least thermal conditioning of the FCPS when the ambient temperature is below an ambient temperature threshold corresponding to a freezing condition of the FCPS.

8. The fuel cell wakeup and conditioning system of claim 1, wherein the control system is configured to control the humidity conditioning system such that a humidity in the FCPS is below a first humidity threshold corresponding to a freezing condition of the FCPS and above a lower second humidity threshold corresponding to a potentially damaging drying condition of the FCPS.

9. The fuel cell wakeup and conditioning system of claim 8, wherein the humidity conditioning system comprises a humidifier.

10. A fuel cell wakeup and conditioning method for a fuel cell electric vehicle (FCEV), the fuel cell wakeup and conditioning method comprising:
providing a thermal conditioning system configured to control a temperature of a fuel cell power system (FCPS) of the FCEV, wherein the FCPS comprises a hydrogen (H2) fuel cell stack that is configured to selectively generate electrical energy for recharging a high voltage battery system of the FCEV;
providing a humidity conditioning system configured to control a humidity of the FCPS;
initiating, by a control system of the FCEV, a wakeup timer for periodically waking up the FCPS to perform at least one of thermal and humidity conditioning;
based on the wakeup timer, a state of charge (SOC) of the high voltage battery system of the FCEV, and an ambient temperature, determining, by the control system, whether to perform (i) only thermal conditioning of the FCPS or (ii) both thermal and humidity conditioning of the FCPS; and
based on the determination, controlling, by the control system, only the thermal conditioning system to perform thermal conditioning of the FCPS or (ii) both the thermal and humidity conditioning systems to perform thermal and humidity conditioning of the FCPS.

11. The fuel cell wakeup and conditioning method of claim 10, wherein the determining of whether to perform (i) only thermal conditioning of the FCPS or (ii) both thermal and humidity conditioning of the FCPS is performed in response to expiration of the wakeup timer.

12. The fuel cell wakeup and conditioning method of claim 11, further comprising, after the thermal only or thermal and humidity conditioning of the FCPS, recalculating, by the control system, the wakeup timer for a subsequent periodic wakeup and conditioning event.

13. The fuel cell wakeup and conditioning method of claim 12, wherein the wakeup timer (tₜᵢₘₑᵣ) is calculated as:
$${T}_{FCmin} = {T}_{a m b} + ( {T}_{0} - {T}_{a m b} ) {e}^{- HWD * {t}_{t i m e r}} , and$$
$${t}_{timer} = \frac{1}{{r}_{fc}} ln ( \frac{{T}_{FCmin} - {T}_{a m b}}{{T}_{0} - {T}_{a m b}} ) ,$$
where r_{fc} represents is a fuel cell constant or rate of change, T_{amb} represents the ambient temperature, To represents a timer measured at shutdown of the FCPS and updated upon each wakeup after conditioning and to estimate subsequent timers, HWD represents a fuel cell hardware decay rate, and T_{FCmin} represents a minimum fuel cell temperature.

14. The fuel cell wakeup and conditioning method of claim 10, wherein the control system determines to perform only thermal conditioning of the FCPS when the SOC of the high voltage battery system exceeds a maximum SOC threshold.

15. The fuel cell wakeup and conditioning method of claim 10, wherein the control system determines to perform only thermal conditioning of the FCPS when the FCEV is plugged-in for charging of the high voltage battery system.

16. The fuel cell wakeup and conditioning method of claim 10, wherein the control system performs at least thermal conditioning of the FCPS when the ambient temperature is below an ambient temperature threshold corresponding to a freezing condition of the FCPS.

17. The fuel cell wakeup and conditioning method of claim 10, wherein the control system controls the humidity conditioning system such that a humidity in the FCPS is below a first humidity threshold corresponding to a freezing condition of the FCPS and above a lower second humidity threshold corresponding to a potentially damaging drying condition of the FCPS.

18. The fuel cell wakeup and conditioning method of claim 17, wherein the humidity conditioning system comprises a humidifier.
